(19) United States
(12) Patent Application Publication
(10) Pub. No.: US 2008/0309019 A1
(43) Pub. Date: Dec. 18, 2008

(54) SEALING ASSEMBLY FOR ROTARY MACHINES

(75) Inventors: Christopher Edward Wolfe, NISKAYUNA, NY (US); Kartik Mangudi Varadarajan, CAMBRIDGE, MA (US); Mohsen Salehi, Rancho Palos Verdes, CA (US); Bugra Han Ertas, ALBANY, NY (US); Michael Vincent Drexel, DELANSON, NY (US); Biao Fang, CLIFTON PARK, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/762,531

(22) Filed: Jun. 13, 2007

(51) Int. Cl. F16J 15/00

(52) U.S. Cl. 277/420; 277/355; 277/411; 277/580; 418/149

(57) ABSTRACT

A sealing assembly is provided. The sealing assembly includes a foil disposed circumferentially around a rotating component and configured to provide primary sealing to the rotating component between high pressure and low pressure sides and a spring system disposed adjacent to the foil. The spring system includes a plurality of features to facilitate foil surface to follow excursions of the rotating component, wherein the plurality of features provide secondary sealing from the high pressure to the low pressure sides between the foil and a stationary component.

### BACKGROUND

The invention relates generally to sealing systems for rotary machines, and more particularly, to a compliant sealing assembly for minimizing leakage of fluid during operating conditions of a rotary machine.

Various types of rotary machines are known and are in use. Typically, efficiency of rotary machines depends upon internal tolerances of components of the machine. For example, a loosely-toleranced rotary machine may have a relatively poor fit between internal components and may therefore exhibit poor efficiency, with relatively high leakage occurring within the device from regions of high pressure to regions of lower pressure.

Sealing systems are used in rotary machines to reduce leakage of fluid flowing through the rotary machines. The sealing systems are often subjected to relatively high temperatures, thermal gradients, and thermal expansion and contraction of the components during various operational stages. The clearance can increase or decrease during various operational stages of the rotary machine. For example, interstage seals on gas turbines are limited in their performance as the clearance changes from start-up to steady state operating conditions. Typical sealing systems applied to such location include labyrinth and brush seals. In case of labyrinth seals, clearances are set based upon a turbine pinch with a pre-determined margin. However, the extra clearance may reduce the efficiency and performance of the rotary machine, as extra leakage occurs across the seal. Further, in case of brush seals, the duration and loading during the turbine pinch results in significant wear to the seal thereby resulting in limited performance of such seals.

Accordingly, there is a need for a sealing system that has improved sealing performance and reduced losses. Furthermore, it would be desirable to provide a sealing system that is capable of operating reliably even in presence of large rotor excursions of rotary machines.

### BRIEF DESCRIPTION

Briefly, according to one embodiment of the invention, a sealing assembly is provided. The sealing assembly includes a foil disposed circumferentially around a rotating component and configured to provide primary sealing to the rotating component between high pressure and low pressure sides and a spring system disposed adjacent to the foil. The spring system includes a plurality of features to facilitate foil surface to follow excursions of the rotating component, wherein the plurality of features provide secondary sealing to the rotating component between the high pressure and low pressure sides and a sealing surface configured to provide sealing between the foil and a stationary component.

In another embodiment, a sealing assembly is provided. The sealing assembly includes an annular segmented component having a plurality of arcuate segments arranged in a circumferential array and a plurality of foil seal segments coupled to the plurality of the arcuate segments. Each of the foil seal segment includes a foil coupled to the seal segment through an attachment mechanism and a spring system disposed adjacent to the foil and including a plurality of features to facilitate the foil surface to follow excursions of a rotating component.

In another embodiment, a rotary machine is provided. The rotary machine includes a stationary component, a rotating component and a sealing assembly. The sealing assembly includes a foil disposed circumferentially around the rotating component and configured to maintain a desired spacing between the foil and the rotating component to provide primary sealing to the rotating component between high pressure and low pressure sides and a spring system disposed adjacent to the foil and including a plurality of features to facilitate the foil surface to follow excursions of the rotating component, wherein the plurality of features provide secondary sealing to the rotating component between the high pressure and low pressure sides, wherein the spring system comprises a sealing surface configured to provide sealing between the foil and the stationary component.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary sealing assembly for a rotating component of a rotary machine in accordance with aspects of the present technique.

FIG. 2 illustrates another exemplary configuration of the sealing assembly for the rotating component of the rotary machine of FIG. 1 in accordance with aspects of the present technique.

FIG. 3 illustrates another exemplary configuration of the sealing assembly for the rotating component of the rotary machine of FIG. 1 in accordance with aspects of the present technique.

FIG. 4 illustrates an exemplary configuration of an unwrapped foil of the spring system employed in the sealing assembly of FIG. 1.

FIG. 5 is a diagrammatical illustration of an exemplary configuration of the spring system of FIG. 4 in accordance with aspects of the present technique.

FIG. 6 is a diagrammatical illustration of another exemplary configuration of the spring system of FIG. 4 in accordance with aspects of the present technique.

FIG. 7 is a diagrammatical illustration of an exemplary spring element employed in the spring system of FIG. 4 in accordance with aspects of the present technique.

FIG. 8 is a diagrammatical illustration of an exemplary foil-spring module having a plurality of spring elements of FIG. 7 for the spring system of FIG. 4 in accordance with aspects of the present technique.

FIG. 9 is a diagrammatical illustration of another exemplary configuration of the spring system of FIG. 4 in accordance with aspects of the present technique.

FIG. 10 is a diagrammatical illustration of an exemplary configuration of the spring system of FIG. 4 in accordance with aspects of the present technique.

FIG. 11 is a diagrammatical illustration of an exemplary configuration of the rotating component of FIG. 1 having the spring system of FIG. 10 in accordance with aspects of the present technique.

FIG. 12 illustrates an exemplary foil having a pattern employed in the sealing assembly of FIG. 1 in accordance with aspects of the present technique.

FIG. 13 is a diagrammatical illustration of an exemplary configuration of a segmented seal for an annular segmented component in accordance with aspects of the present technique.

FIG. 14 is a diagrammatical illustration of another exemplary configuration of the segmented seal of FIG. 13 in accordance with aspects of the present technique.

FIG. 15 illustrates an exemplary configuration of the seal segment of the sealing assembly of FIG. 14 in accordance with aspects of the present technique.

FIG. 16 is a diagrammatical illustration of an exemplary alternate configuration of the sealing assembly of FIG. 15 in accordance with aspects of the present technique.

FIG. 17 illustrates another exemplary configuration of the seal segment of FIG. 15 in accordance with aspects of the present technique.

FIG. 18 illustrates an exemplary configuration of the seal segment of the sealing assembly of FIG. 14 in accordance with aspects of the present technique.

FIG. 19 illustrates an exemplary alternate configuration of the seal segment of FIG. 18 in accordance with aspects of the present technique.

FIG. 20 illustrates another exemplary configuration of the seal segment of FIG. 18 in accordance with aspects of the present technique.

FIG. 21 illustrates an exemplary configuration of the seal segment of the sealing system of FIG. 14 in accordance with aspects of the present technique.

FIG. 22 illustrates another exemplary configuration of the seal segment of FIG. 21 in accordance with aspects of the present technique.

FIG. 23 illustrates another exemplary configuration of seal segments of FIGS. 21 and 22 having an additional foil piece coupled to the seal segment in accordance with aspects of the present technique.

FIG. 24 illustrates an exemplary configuration of the seal segment of the sealing system of FIG. 14 in accordance with aspects of the present technique.

FIG. 25 illustrates an exemplary alternate configuration of the seal segment of FIG. 21 in accordance with aspects of the present technique.

FIG. 26 illustrates an exemplary configuration of the seal segment of the sealing system of FIG. 14 in accordance with aspects of the present technique.

FIG. 27 illustrates an exemplary attachment mechanism for attaching the plurality of spring elements to the seal segment of FIG. 26 in accordance with aspects of the present technique.

FIG. 28 illustrates another exemplary attachment mechanism for attaching the plurality of spring elements to the seal segment of FIG. 26 in accordance with aspects of the present technique.

FIG. 29 illustrates another exemplary attachment mechanism for attaching the plurality of spring elements to the seal segment of FIG. 26 in accordance with aspects of the present technique.

FIG. 30 is a diagrammatical illustration of an exemplary package for protecting a seal segment having a foil seal during transportation and storage operations in accordance with aspects of the present technique.

FIG. 31 illustrates an exemplary attachment mechanism for attaching a seal segment with a segment of an annular segmented component in accordance with aspects of the present technique.

FIG. 32 illustrates another exemplary attachment mechanism for attaching a seal segment with a segment of an annular segmented component in accordance with aspects of the present technique.

### DETAILED DESCRIPTION

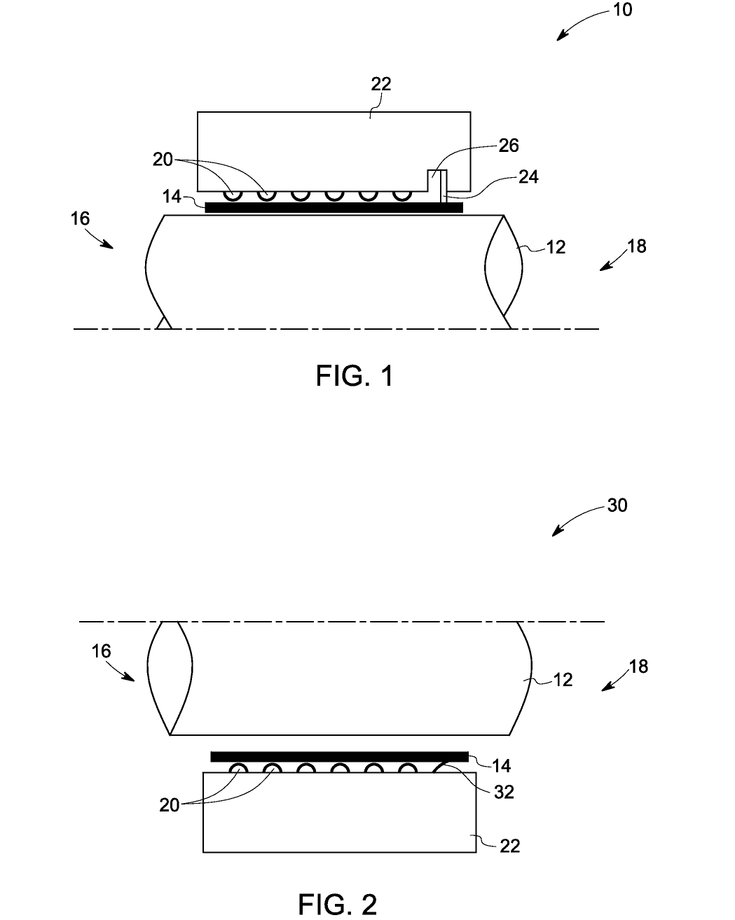

As discussed in detail below, embodiments of the present invention function to provide a compliant sealing assembly for minimizing leakage of fluid during operating conditions of a rotary machine. In particular, the present technique provides a sealing assembly that is capable of operating even in presence of large rotor excursions of rotary machines and can also be employed for applications that require a segmented construction. Referring now to the drawings, FIG. 1 illustrates an exemplary sealing assembly 10 for a rotating component 12 of a rotary machine. The sealing assembly 10 includes a foil 14 disposed circumferentially around the rotating component 10 and configured to provide primary sealing to the rotating component 12 between high pressure and low pressure sides 16 and 18. In this exemplary embodiment, the foil 14 comprises a sheet metal strip.

Further, the seal assembly 10 includes a spring system 20 disposed adjacent to the foil 14 and within a housing 22. The spring system 20 includes a plurality of features to facilitate the foil surface to follow excursions of the rotating component 12 and to provide secondary sealing to the rotating component 12 between the high pressure and low pressure sides 16 and 18. In addition, the spring system 20 includes a sealing surface 24 configured to provide sealing between the foil 14 and the housing 22. The housing 22 then fits into a stationary component (not shown) of the rotary machine. The plurality of features of the spring system 20 and the sealing surface 24 will be described in a greater detail below.

In operation, a fluid film is formed between the rotating component 12 and the foil 14 due to the rotation of the rotating component 12 and the presence of a pressure difference across the sealing assembly 10. The fluid film facilitates a non-contact operation of the sealing assembly 10 and the spring system 20 facilitates the foil surface to follow the excursions of the rotating component 12.

The present technique utilizes a combination of the secondary sealing, between the foil 14 and the housing 22, with the spring system 20 to facilitate operation even in presence of large rotor excursions. In particular, the sealing surface 24 includes brush seal segments attached to the housing 22. In this exemplary embodiment, bristle free ends of the brush seal segments are disposed on the foil 14. In one exemplary embodiment, the brush seal segments are received within a housing slot 26 in the housing 22.

FIG. 2 illustrates another exemplary configuration 30 of the sealing assembly for the rotating component 12 of the rotary machine. In this exemplary embodiment, the sealing assembly 30 includes a sealing surface 32 that consists of a foil attached to the housing 22. In this exemplary embodiment, free end of the foil is disposed on the foil 14. Advantageously, the sealing surfaces 24 and 32 described above provide both sealing and elastic support to the foil 14. However, other types of sealing surfaces may be envisaged.

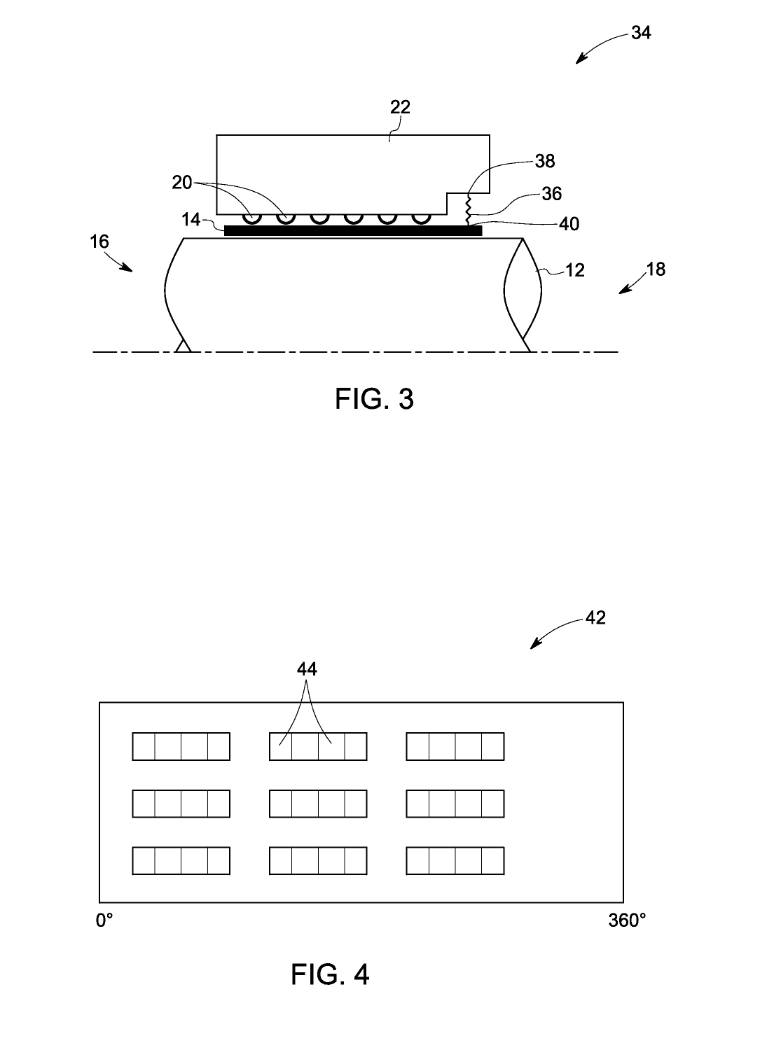

FIG. 3 illustrates another exemplary configuration 34 of the sealing assembly 10 for the rotating component 12 of the rotary machine. In this exemplary embodiment, the sealing assembly 34 includes bellows 36 to provide the secondary sealing between the foil 14 and the housing 22. In this exemplary embodiment, an upper end 38 of the bellows 36 may be welded to the seal housing 22. Further, a lower end 40 of the bellows 36 may be either welded to the foil 14 or may be in resilient contact with the foil 14.

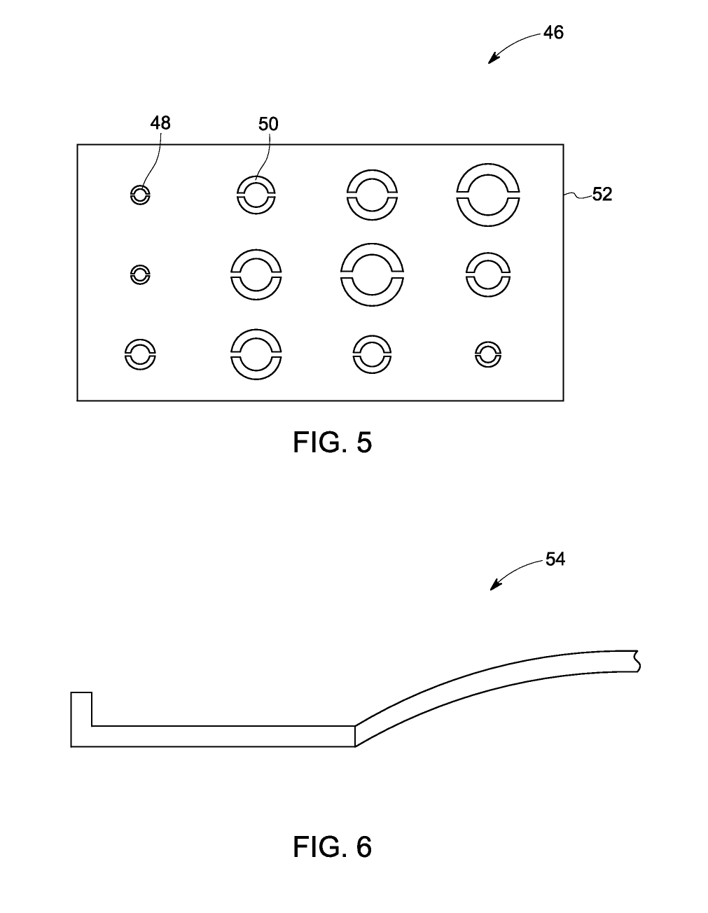

FIG. 4 illustrates an exemplary configuration 42 of an unwrapped foil of the spring system 20 employed in the sealing assembly 10 of FIG. 1. As illustrated, the foil 42 includes a plurality of features 44 to facilitate foil surface to follow excursions of the rotating component 12 and to provide secondary sealing to the rotating component 12 between the high pressure and low pressure sides 16 and 18 respectively. The plurality of features 44 may include bump foils, foils with beams incorporated, foils with elastic bump features incorporated and so forth. Exemplary configurations of the features 44 will be described in detail below with reference to FIGS. 5-11.

FIG. 5 is a diagrammatical illustration of an exemplary configuration 46 of the spring system 42 of FIG. 4. In this exemplary configuration, the spring system 46 includes a plurality of spring elements such as represented by reference numerals 48 and 50 formed on a sheet metal 52. The spring elements 48 and 50 are formed by punching features of varying geometry and size on the sheet metal 52. It should be noted that a geometry and size of the plurality of features such as 48 and 50 may be selected to achieve a desired spring stiffness. FIG. 6 is a diagrammatical illustration of another exemplary configuration 54 of the spring system 42 of FIG. 4. In the illustrated embodiment, the spring system 54 consists of a plurality of leaf springs that may have varying widths and thicknesses for providing an axially varying spring stiffness, or circumferentially varying spring stiffness, or combinations thereof.

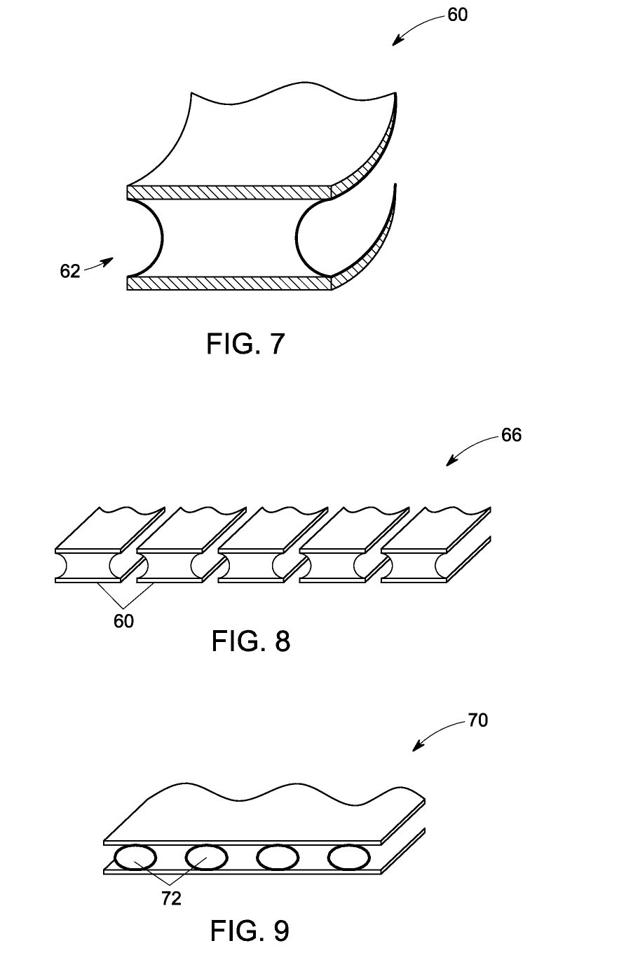

FIG. 7 is a diagrammatical illustration of an exemplary spring element 60 employed in the spring system 42 of FIG. 4 in accordance with aspects of the present technique. The spring element 60 includes circumferentially bent strips of metal or tubes 62 having a plurality of shapes. In this exemplary embodiment, the spring element 60 includes circumferentially bent strips of metal or tubes 62 having a C-shaped cross-section. The spring elements 60 are configured to provide secondary sealing to the rotating component 12 (see FIG. 1). In certain embodiments, the sealing assembly 10 (see FIG. 1) may include a plurality of spring elements 60 disposed adjacent the foil 14 (see FIG. 1). In an alternate embodiment, the sealing assembly 10 may include a plurality of foil-spring modules as described below with reference to FIG. 8.

FIG. 8 is a diagrammatical illustration of an exemplary foil-spring module 66 having a plurality of spring elements 60 of FIG. 7 for the spring system 42 of FIG. 4 in accordance with aspects of the present technique. As illustrated, the foil-spring module 66 includes a plurality of spring elements 60 coupled in series to achieve a desired spring stiffness. Again, a plurality of shapes and sizes 60 may be envisaged for the spring elements 62 to achieve the desired spring stiffness. FIG. 9 is a diagrammatical illustration of another exemplary configuration 70 of the spring system 42 of FIG. 4. In this embodiment, the spring system 70 includes a plurality of spring elements 72 formed of circumferentially bent strips of metal, or tubes having an oval cross-section. In an alternate embodiment, the spring elements 72 may include split tubes. However, other shapes of the spring elements 72 may be envisaged.

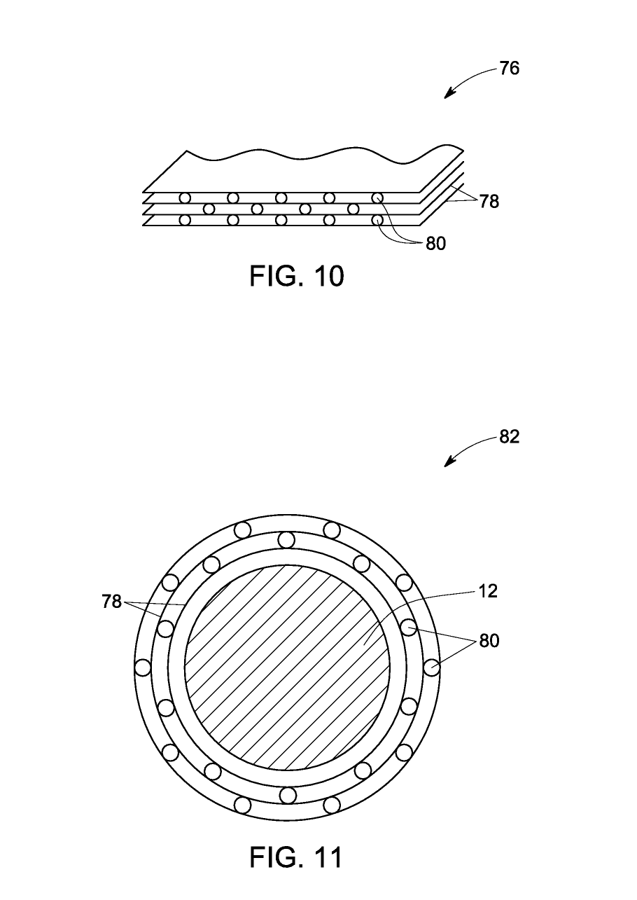

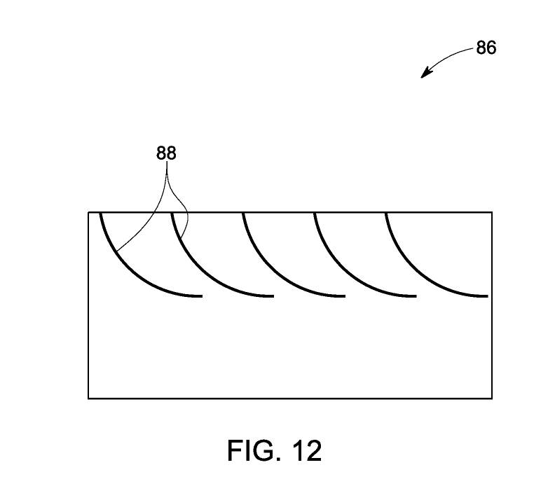

FIG. 10 is a diagrammatical illustration of an exemplary configuration 76 of the spring system 42 of FIG. 4. The spring system 76 includes alternating layers of sheet metal 78 and wires or flexible rods 80. FIG. 11 is a diagrammatical illustration of an exemplary configuration 82 of the rotating component 12 of FIG. 1 having the spring system 76 of FIG. 10 in accordance with aspects of the present technique. As illustrated, the spring system 76 includes the alternating layers of sheet metal 78 and the wires or rods 80. Further, the innermost layer of the sheet metal 78 forms the fluid film with the rotating component 12, which facilitates a non-contact operation of the sealing assembly 10 (see FIG. 1).

As described above, the spring system 42 may include a plurality of features of varying geometry and size to provide the secondary sealing to the rotating component 12 (see FIG. 1). In certain embodiments, the foil 14 may include a plurality of features etched on the foil surface and configured to substantially prevent air flow across the foil 14. FIG. 12 illustrates an exemplary foil 86 having a pattern 88 employed in the sealing assembly 10 of FIG. 1. As illustrated, the foil 86 includes a plurality of grooves 88 in the foil 86 for preventing the air flow across the foil 86. Examples of other patterns include chevrons, scoops etc.

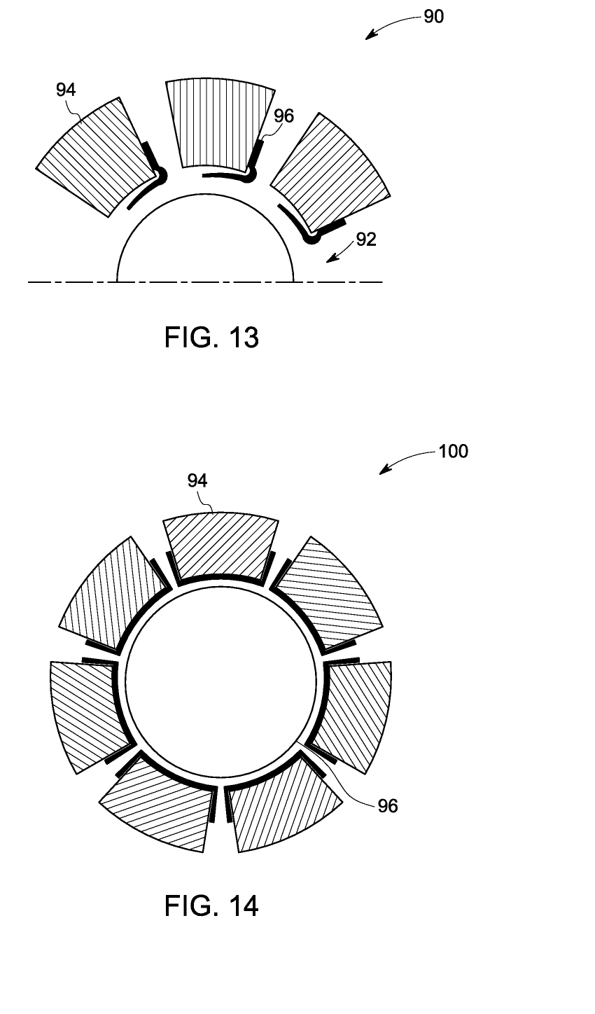

The sealing assembly 10 described above may be employed for applications that require a segmented construction. For example, the sealing assembly may be employed for annular segmented components such as a turbine nozzle, turbine shroud etc. FIGS. 13-29 Illustrate exemplary configurations of the sealing assembly for such annular segmented components.

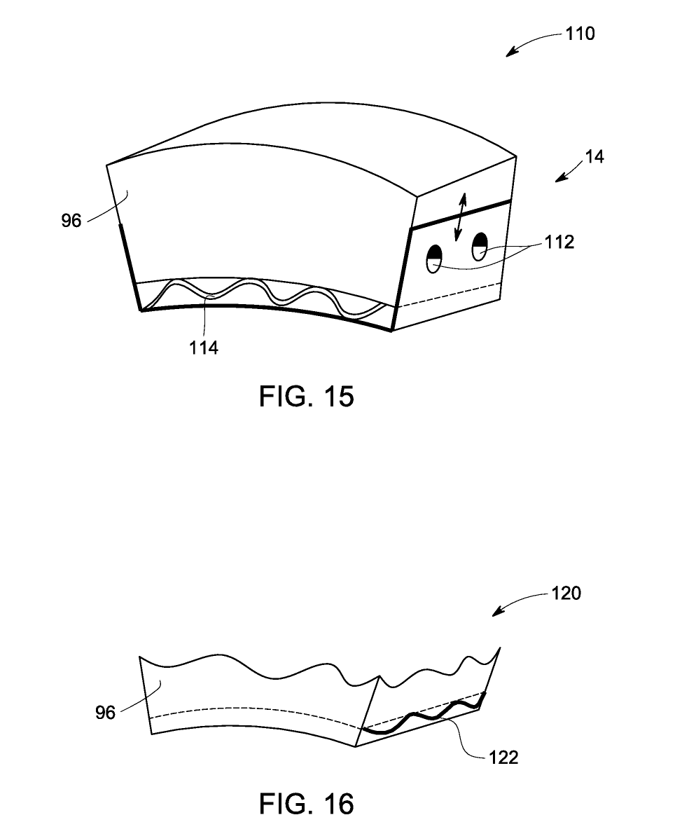

FIG. 13 is a diagrammatical illustration of an exemplary configuration 90 of a segmented seal for an annular segmented component 92. As illustrated, the annular segmented component 92 includes a plurality of arcuate segments such as represented by reference numeral 94 that are arranged in a circumferential array. Further, a plurality of foil seal segments 96 are coupled to the arcuate segments 94. The foil segments 96 include the foil 14 (see FIG. 1) and the spring system 20 (see FIG. 1), as described above. In this exemplary embodiment, the foil 14 is attached to the segment 94 at one of the circumferential ends. FIG. 14 is a diagrammatical illustration of another exemplary configuration 100 of the segmented seal of FIG. 13. In this embodiment, the foil 96 is attached to the segment 94 at each of the circumferential ends of the segment 94. The attachment of the foil 96 to the seal segment 94 will be described below with reference to FIGS. 15-29.

FIG. 15 illustrates an exemplary configuration 110 of the seal segment 96 of the sealing assembly 100 of FIG. 14. In the illustrated embodiment, the foil 14 is coupled to the seal segment 96 through a pin-in-slot arrangement 112. The pin-in-slot arrangement 112 facilitates a radial movement of the foil 14. Further, spring system 20 may consist of a combination of bump foil or spring foil with cantilever beam patterns with a secondary seal such as a brush seal of leaf spring, or of a foil with combined springs/secondary seals attached as discussed above. FIG. 16 is a diagrammatical illustration of an exemplary alternate configuration 120 of the sealing assembly 110 of FIG. 15. In this exemplary embodiment, the foil 14 is coupled to the seal segment 96 through the pin-in-slot arrangement 112 (see FIG. 16).

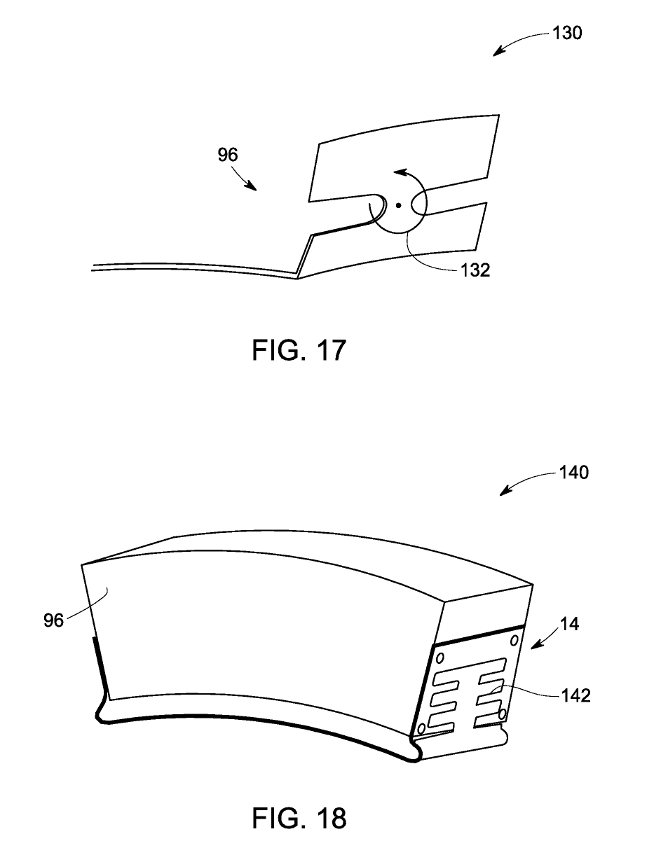

FIG. 17 illustrates another exemplary configuration 130 of the seal segment 96 of FIG. 15. As described above, the foil 14 is coupled to the seal segment 96 through the pin-in-slot arrangement 112 (see FIG. 15). In addition, a pivot feature 132 is added to the foil 14 for facilitating additional compliance of the foil 14. Again, as described above, the spring system 20 may consist of a combination of bump foil or spring foil with cantilever beam patterns with a secondary seal such as a brush seal of leaf spring, or of a foil with combined springs/secondary seals attached.

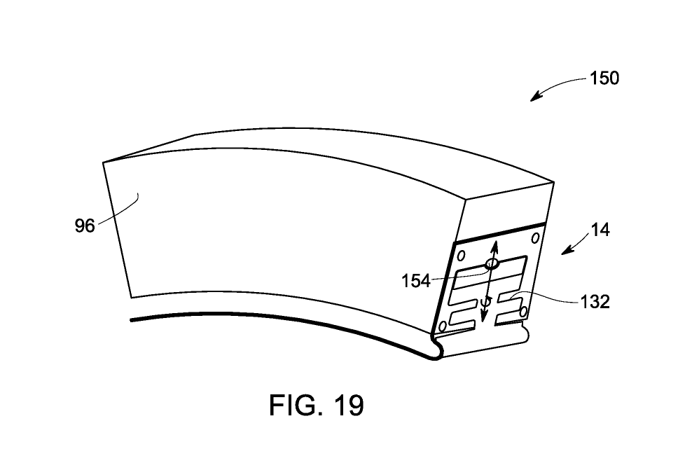

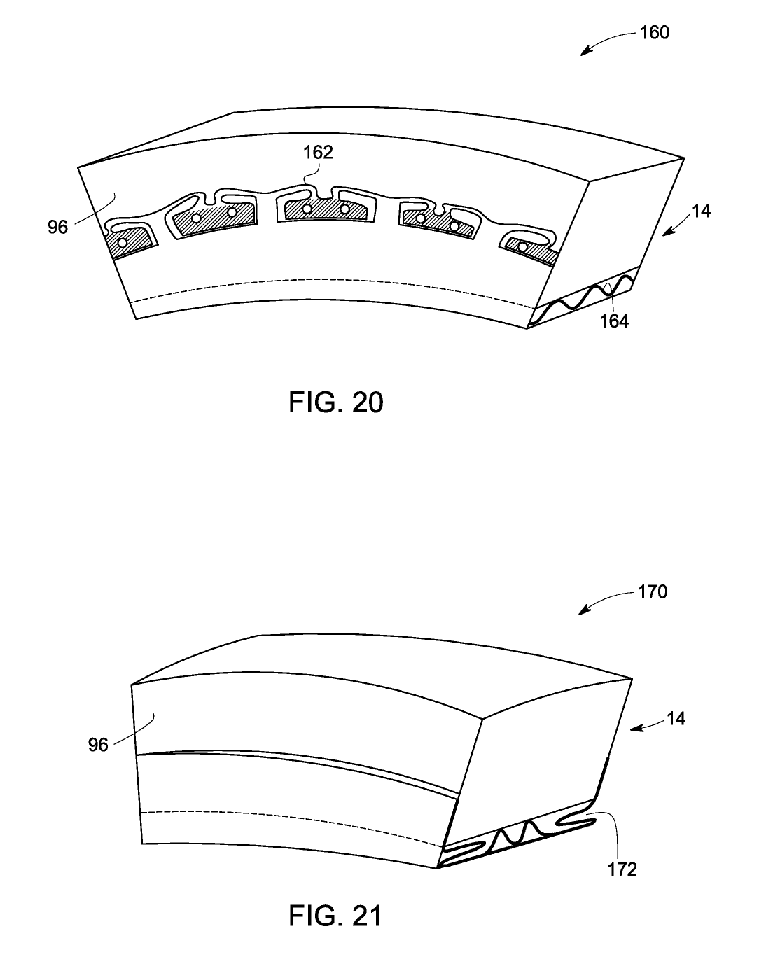

FIG. 18 illustrates an exemplary configuration 140 of the seal segment 96 of the sealing assembly 100 of FIG. 14. As illustrated, the foil 14 is coupled to the seal segment 96 through a plurality of flexures 142 oriented in a circumferential direction. The plurality of flexures 142 facilitate the radial movement of the foil 14. In this exemplary embodiment, the plurality of flexures 142 include compliant beams. FIG. 19 illustrates an exemplary alternate configuration 150 of the seal segment 140 of FIG. 18. In this configuration, the foil 14 is coupled to the seal segment 96 through a plurality of flexures 152 having a pivot feature 154. Further, the spring system 20 may consist of a combination of bump foil or spring foil with cantilever beam patterns with a secondary seal such as a brush seal of leaf spring, or of a foil with combined springs/secondary seals attached as described above. FIG. 20 illustrates another exemplary configuration 160 of the seal segment 140 of FIG. 18. In this exemplary embodiment, the foil 14 is coupled to the seal segment 96 through a plurality of flexures 162 in an axial direction. Further, bumps 164 disposed in the circumferential direction are configured to provide the secondary sealing.

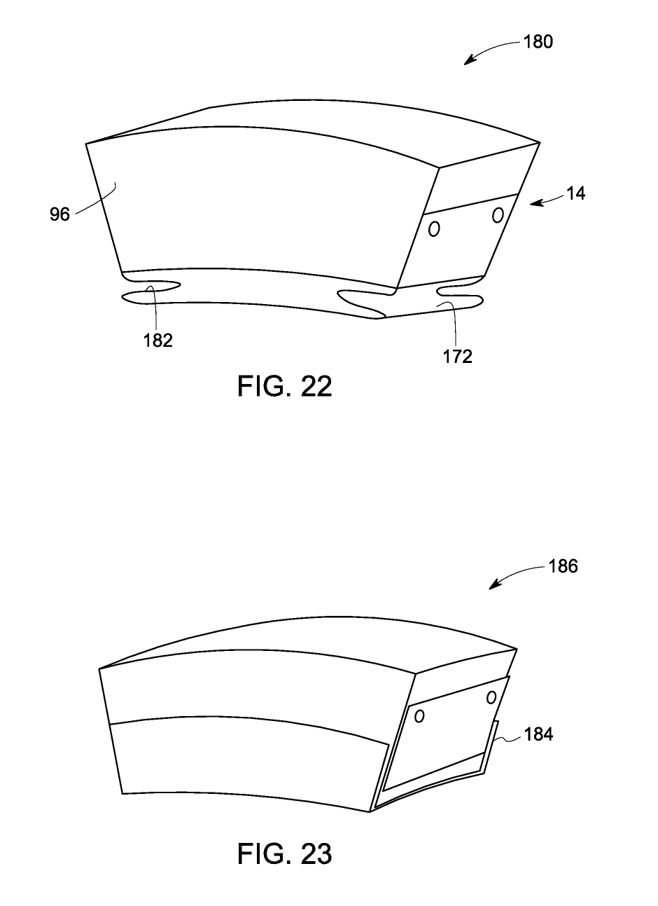

FIG. 21 illustrates an exemplary configuration 170 of the seal segment 96 of the sealing system 100 of FIG. 14. In the illustrated embodiment, the foil 14 is coupled to the seal segment 96 through a plurality of folds 172 disposed in an axial direction. In particular, the plurality of folds 172 function as flexural elements to facilitate radial motion of the foil 14. FIG. 22 illustrates another exemplary configuration 180 of the seal segment 170 of FIG. 21. As illustrated, the foil 14 is coupled to the seal segment 96 through the plurality of folds 172 in the axial direction. In addition, a plurality of folds 182 are employed to couple the foil 14 with the seal segment 96 in the circumferential direction. Furthermore, any leakage through the folds 172 and 182 may be prevented by coupling an additional foil piece 184 to the foil 14 as illustrated in an exemplary configuration 186 of FIG. 23. The additional foil piece 184 may be welded or connected by any other means to the housing 96 with the folds 172 and 182.

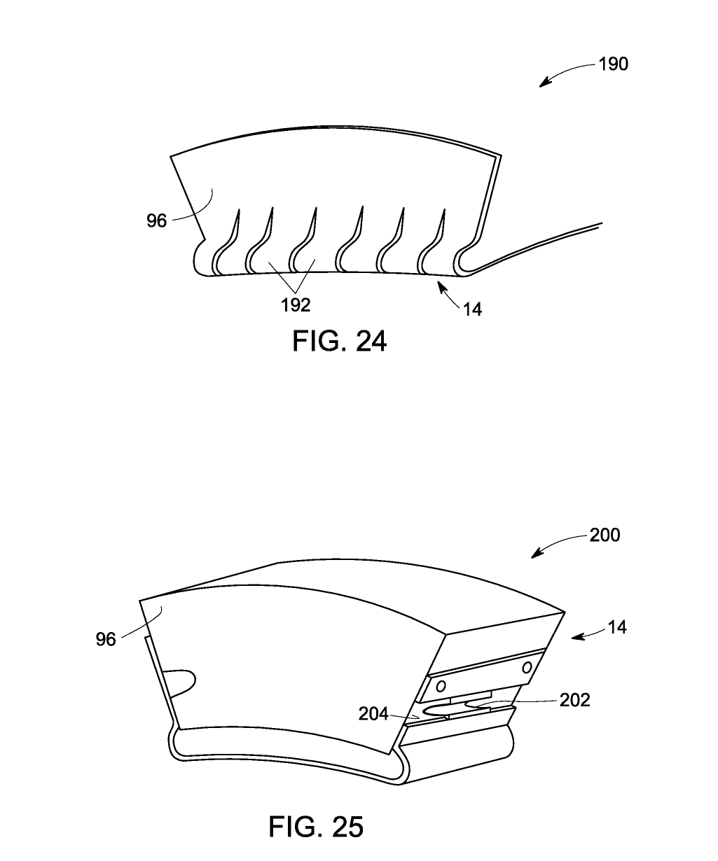

FIG. 24 illustrates an exemplary configuration 190 of the seal segment 96 of the sealing system 100 of FIG. 14. In this exemplary embodiment, the seal segment 190 includes a plurality of slits 192 disposed on the foil 14 for decreasing the axial stiffness of the foil 14. FIG. 25 illustrates an exemplary alternate configuration 200 of the seal segment 170 of FIG. 21. In this exemplary embodiment, the foil 14 is coupled to the seal segment 96 through a plurality of folds 202 in an axial direction. Further, the plurality of folds 202 are disposed within slots 204 to substantially prevent leakage through the plurality of folds 202.

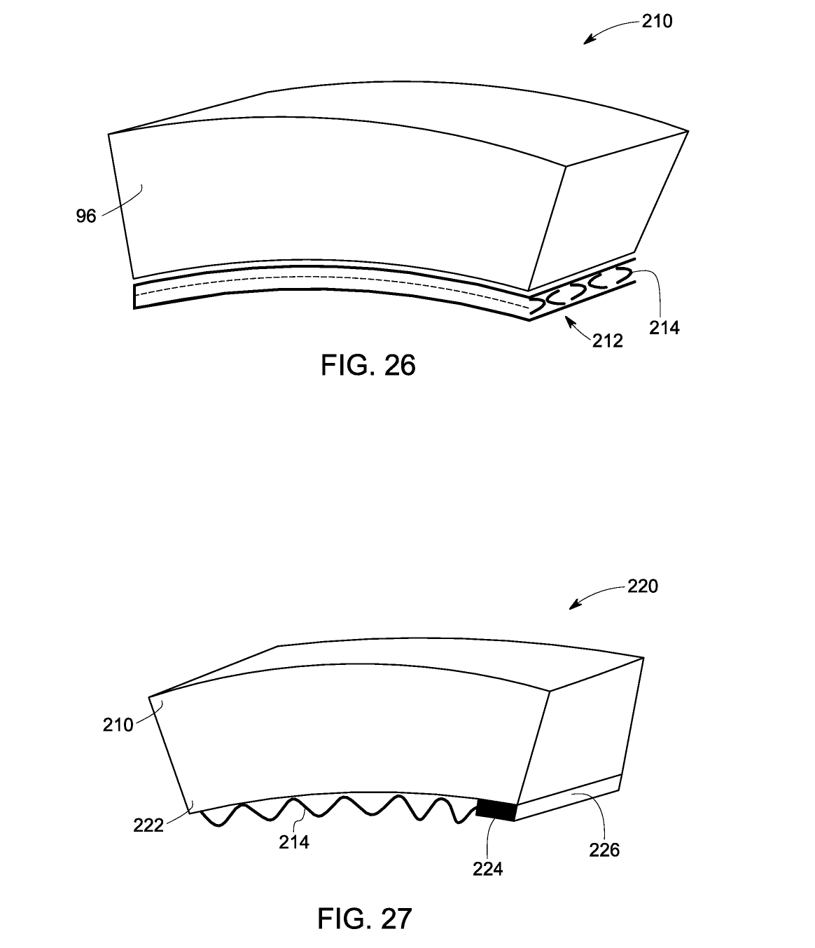

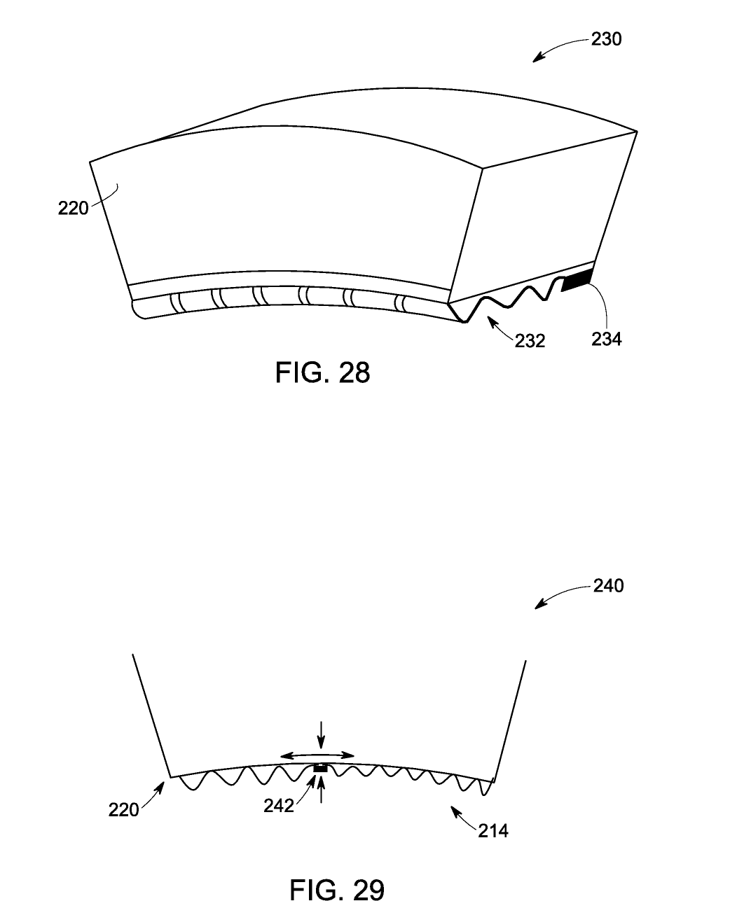

FIG. 26 illustrates an exemplary configuration 210 of the seal segment 96 of the sealing system 100 of FIG. 14. In this embodiment, a foil-seal module 212 having a foil and a plurality of spring elements 214 are coupled to the bottom of the seal segment 96. The foil-seal module 212 may be coupled to the bottom of the seal segment 96 through welding. However, other attachment mechanisms may be envisaged. FIG. 27 illustrates an exemplary attachment mechanism 220 for attaching the plurality of spring elements 214 to the seal segment 210 of FIG. 26. As illustrated, the spring elements 214 are rigidly coupled to the seal segment 210 at a first end 222 through welding or bonding. Further, on a second end 224 the spring elements 214 are disposed within a slotted attachment 226 with sufficient clearance to allow for translation on account of increase in circumferential length of the spring elements 214. FIG. 28 illustrates another exemplary attachment mechanism 230 for attaching the plurality of spring elements 214 to the seal segment 210 of FIG. 26. In this exemplary configuration, a plurality of springs 232 oriented in an axial direction are coupled to the seal segment 210 through a slotted attachment 234 on one end and are welded or bonded to the seal segment 210 at the other end. In certain embodiments, the spring elements 232 may be formed by cutting fingers in a sheet metal and subsequently bending them to form the bumps.

FIG. 29 illustrates another exemplary attachment mechanism 240 for attaching the plurality of spring elements 214 to the seal segment 210 of FIG. 26. In this exemplary configuration, the plurality of spring elements 214 are split and supported by a slotted attachment 242 at the middle of the segment 210. Advantageously, the split arrangement of the plurality of spring elements 214 allows for relatively better conformance of the spring elements 214 to the seal segment body and the rotor.

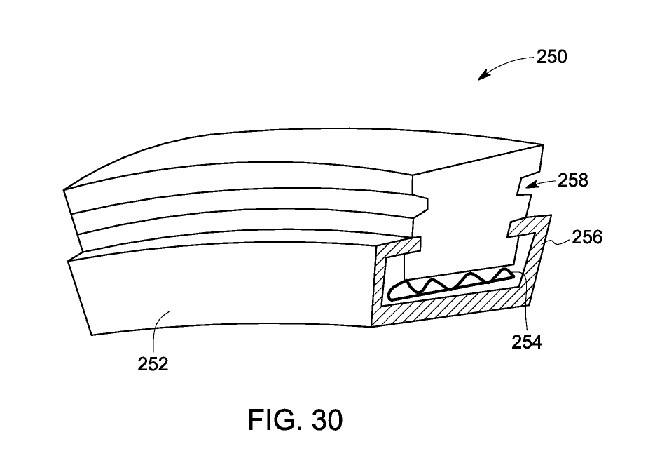

FIG. 30 is a diagrammatical illustration of an exemplary package 250 for protecting a seal segment 252 having a foil seal 254 during transportation and storage operations. As illustrated, a protective shell 256 may be slid onto the seal segment 252 during transportation and storage operations for protecting the seal segment 252 from any damage. The protective shell 256 may be removed just prior to installation of the seal segment 252. In certain embodiments, the seal 254 may be slid into a mounting slot 258 and then the protective shell 256 may be removed prior to its installation. In certain embodiments, the protective shell 256 may be removed after the seal segment 252 is installed, leaving the shell 256 in place while the machine remains open.

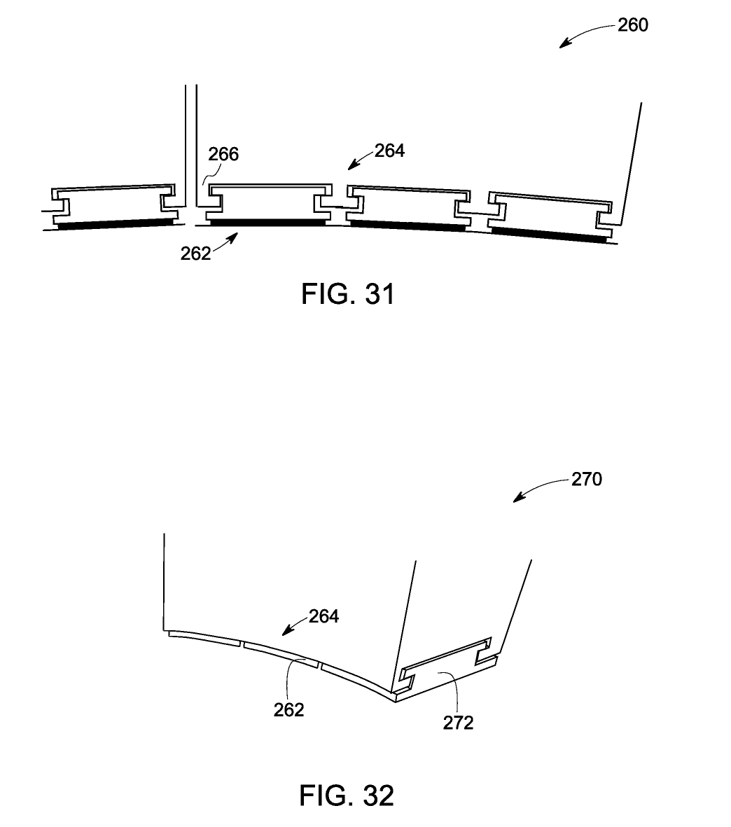

The plurality of segmented designs of the seal assembly described above may be employed for components that require a segmented construction. Examples of such components include a turbine nozzle and a turbine shroud assembly in a gas turbine. Further, the segmented seal assembly includes a foil and a spring system having a plurality of features to facilitate the foil surface to follow excursions of a rotating component. Again, the plurality of features may include bump foils, foils with beams incorporated or foils with elastic bump features incorporated and so forth as described earlier with reference to FIGS. 5-11. The segmented configuration of the seal assembly may be coupled with the segmented component such as turbine nozzle as described below with reference to FIGS. 31 and 32.

FIG. 31 illustrates an exemplary attachment mechanism 260 for attaching a seal segment such as represented by reference numeral 262 with a segment 264 of an annular segmented component. In this exemplary embodiment, the segment 264 includes a nozzle segment. As illustrated, the seal segment 262 is coupled to the nozzle segment 264 using axially oriented slots 266. Again, each of the seal segment 262 may be designed based upon different segmentation concepts and may include a variety of patterns of the spring elements as described above. FIG. 32 illustrates another exemplary attachment mechanism 270 for attaching the seal segment 262 with the segment 264 of an annular segmented component. In this exemplary embodiment, the seal segment 262 is coupled to the segment 264 through tangentially oriented slots 272.

The various aspects of the technique described above may be used for providing improved sealing for components such as for gas turbine interstage locations. In particular, the sealing systems described above can be employed for applications that require large diameters and/or have a segmented construction. Advantageously, such sealing systems have the capability of operating reliably even in presence of large rotor excursions and have an improved sealing performance thereby resulting in reduced losses.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A sealing assembly, comprising:
a foil disposed circumferentially around a rotating component and configured to provide primary sealing to the rotating component between high pressure and low pressure sides; and
a spring system disposed adjacent to the foil, wherein the spring system comprises:
a plurality of features to facilitate foil surface to follow excursions of the rotating component, wherein the plurality of features provide secondary sealing to the rotating component between the high pressure and low pressure sides; and
a sealing surface configured to provide sealing between the foil and a stationary component.

2. The sealing assembly of claim 1, wherein a fluid film formed between the rotating component and the foil facilitates non-contact operation of the sealing assembly.

3. The sealing assembly of claim 2, wherein the foil comprises a flange section configured to substantially prevent leakage of the fluid through the plurality of features.

4. The sealing assembly of claim 1, wherein the plurality of features comprise spring elements disposed on the bump foil.

5. The sealing assembly of claim 4, wherein the spring elements comprise features having a plurality of geometric shapes and sizes to achieve a desired distribution of spring stiffness.

6. The sealing assembly of claim 5, wherein the spring elements comprise leaf springs having varying widths and thicknesses for providing an axially varying spring stiffness, or circumferentially varying spring stiffness, or combinations thereof.

7. The sealing assembly of claim 5, wherein the spring elements comprise circumferentially bent strips of metal, or tubes having a plurality of cross-sectional shapes disposed on the bump foil.

8. The sealing assembly of claim 7, further comprising a plurality of foil-spring modules, each foil-spring module having the spring element formed of the circumferentially bent strips of metal, or tubes.

9. The sealing assembly of claim 5, wherein the spring elements comprise alternating layers of a sheet metal and wires, or flexible rods.

10. The sealing assembly of claim 1, wherein the foil comprises a pattern of features etched on the foil surface and configured to substantially prevent air flow across the foil.

11. The sealing assembly of claim 10, wherein the features comprise chevrons, or scoops, or combinations thereof.

12. The sealing assembly of claim 1, wherein the sealing surface comprises brush seal segments coupled to the foil.

13. The sealing assembly of claim 1, wherein the sealing surface comprises a foil coupled to a seal housing of the sealing assembly.

14. The sealing assembly of claim 1, wherein the sealing surface comprises bellows.

15. A sealing assembly, comprising:
an annular segmented component having a plurality of arcuate segments arranged in a circumferential array; and
a plurality of foil seal segments coupled to the plurality of the arcuate segments, wherein each of the foil seal segment comprises:
a foil coupled to the seal segment through an attachment mechanism; and
a spring system disposed adjacent to the foil and including a plurality of features to facilitate the foil surface to follow excursions of a rotating component.

16. The sealing assembly of claim 15, wherein the annular segmented component comprises a turbine nozzle, or a turbine shroud assembly in a gas turbine.

17. The sealing assembly system of claim 16, wherein the foil seal segments are coupled to nozzle segments of the turbine nozzle through axial slots, or tangential slots, or combinations thereof.

18. The sealing assembly of claim 15, wherein the foil is coupled to the foil seal segment through a pin-in-slot mechanism configured to facilitate radial movement of the foil.

19. The sealing assembly of claim 18, wherein the plurality of features comprise spring elements oriented in an axial or a circumferential direction.

20. The sealing assembly of claim 15, further comprising a pivot feature configured to facilitate a pivoting movement of the foil.

21. The sealing assembly of claim 15, wherein the foil is coupled to the foil seal segment through a plurality of flexures, wherein the plurality of flexures are provided in an axial direction, or a circumferential direction of the seal segment, or combinations thereof.

22. The sealing assembly of claim 21, further comprising a pivot feature coupled to the plurality of flexures and configured to facilitate a pivoting movement of the foil.

23. The sealing assembly of claim 15, wherein the foil comprises a plurality of folds in an axial direction, or in a circumferential direction, or combinations thereof.

24. The sealing assembly of claim 23, wherein the plurality of folds are disposed within slots in the foil seal segments to substantially prevent leakage through the plurality of folds.

25. The sealing assembly of claim 15, further comprising a plurality of slits disposed on the foil for reducing a stiffness of the foil.

26. The sealing assembly of claim 15, wherein a foil seal module having the foil and the bump foil with the plurality of features is coupled to each of the plurality of foil seal segments.

27. The sealing assembly of claim 26, wherein the plurality of features are coupled to the foil seal segments through welding, or through a slotted attachment.

28. A rotary machine, comprising:
a stationary component;
a rotating component; and
a sealing assembly comprising:
a foil disposed circumferentially around the rotating component and configured to maintain a desired spacing between the foil and the rotating component to provide primary sealing to the rotating component between high pressure and low pressure sides; and
a spring system disposed adjacent to the foil and including a plurality of features to facilitate the foil surface to follow excursions of the rotating component, wherein the plurality of features provide secondary sealing to the rotating component between the high pressure and low pressure sides, wherein the spring system comprises a sealing surface configured to provide sealing between the foil and the stationary component.

29. The rotary machine of claim 28, wherein the rotating component comprises an annular segmented component having a plurality of arcuate segments arranged in a circumferential array and the sealing system comprises a plurality of foil seal segments coupled to the plurality of the arcuate segments.

30. The rotary machine of claim 28, wherein the plurality of features comprises spring elements disposed in the spring system.

31. The rotary machine of claim 28, wherein the spring elements comprise circumferentially bent strips of metal, or tubes having a plurality of cross-sectional shapes disposed on the bump foil, or alternating layers of a sheet metal and wires, or flexible rods.

32. The rotary machine of claim 28, wherein the sealing surface comprises brush seal segments coupled to the foil, or a foil, or bellows, or combinations thereof.

33. A sealing assembly, comprising:
a foil disposed circumferentially around a rotating component and configured to provide primary sealing to the rotating component between high pressure and low pressure sides; and
a spring system disposed adjacent to the foil, wherein the spring system comprises:
a plurality of features to facilitate foil surface to follow excursions of the rotating component, wherein the plurality of features provide secondary sealing to the rotating component between the high pressure and low pressure sides; and
a plurality of brush seal segments coupled to the foil and configured to provide sealing between the foil and a stationary component.
